(19) United States
(12) Patent Application Publication
(10) Pub. No.: US 2026/0201803 A1
(43) Pub. Date: Jul. 16, 2026

(54) AIRFOIL ASSEMBLY HAVING A CAP

(71) Applicant: General Electric Company, Evendale, OH (US)

(72) Inventors: Nevan Eichorn, Cincinnati, OH (US); Wendy W. Lin, Montgomery, OH (US); Trevor H. Wood, Clifton Park, NY (US)

(21) Appl. No.: 19/018,499

(22) Filed: Jan. 13, 2025

(51) Int. Cl. F01D 5/14; F01D 5/28

(52) U.S. Cl. CPC F01D 5/147; F01D 5/282; F05D 2220/36; F05D 2300/43; F05D 2300/603

(57) ABSTRACT

An airfoil assembly has an airfoil portion with an outer wall bounding an interior. The outer wall extends between a root and a tip in a spanwise direction. The outer wall extends between a leading edge and a trailing edge in a chordwise direction. The outer wall includes a cap overlaying a portion of the outer wall. The cap has an exterior surface and corrugations provided along the exterior surface.

### TECHNICAL FIELD

The disclosure generally relates to an airfoil assembly, and more specifically to an airfoil assembly having a cap.

### BACKGROUND

Turbine engines, and particularly gas or combustion turbine engines, are rotary engines that extract energy from a flow of gases passing through a fan with a plurality of fan blades, then into the engine through a series of compressor stages, which include pairs of rotating blades and stationary vanes, through a combustor, and then through a series of turbine stages, which include pairs of rotating blades and stationary vanes. The blades are mounted to rotating disks, while the vanes are mounted to stator disks.

During operation, air is brought into the compressor section through the fan section where it is then pressurized in the compressor, mixed with fuel, and ignited in the combustor for generating hot combustion gases which flow downstream through the turbine stages where the air is expanded and exhausted out an exhaust section. The expansion of the air in the turbine section is used to drive the rotating sections of the fan section and the compressor section. The drawing in of air, the pressurization of the air, and the expansion of the air is done, in part, through rotation of various rotating blades mounted to respective disks throughout the fan section, the compressor section, and the turbine section, respectively. The air flows over the stationary vanes to direct the air in a desired direction.

As the air flows over the rotating blades and the stationary vanes, a wake flow is generated downstream of the respective rotating blades and stationary vanes. The wake flow, in turn, interacts with objects downstream from the rotating blades and the stationary vanes. Due to the helical flow of the wake flow, the wake flow can impinge the downstream objects in an undesired fashion and impart at least one of a torsional stress, a bending stress, or a combination thereof, thus decreasing engine performance and engine efficiency. Wake flow impingement can further produce undesirable noise and heighten aeromechanical loading. Reductions to the amplitude of the wake flow (e.g., a strength of the wake flow velocity perturbation) can reduce the noise and the aeromechanical loading generated when the wake flow impinges against a downstream object.

### BRIEF DESCRIPTION OF THE DRAWINGS

A full and enabling disclosure of the present disclosure, including the best mode thereof and being directed to one of ordinary skill in the art, is set forth in the specification which further references the appended figures where:

FIG. 1 is a schematic cross-sectional view of an unducted or open rotor turbine engine.

FIG. 2 is a schematic perspective view of an airfoil assembly suitable for use within the turbine engine of FIG. 1, the airfoil assembly including an airfoil portion, a cap, a trunnion, and a spar.

FIG. 3 is a schematic cross-sectional view of the airfoil assembly as seen from sectional line III-III of FIG. 2, further illustrating the trunnion and a respective portion of the spar received within the trunnion.

FIG. 4 is a schematic cross-sectional view of the airfoil portion as seen from sectional line IV-IV of FIG. 2, further illustrating the cap provided along a trailing edge of the airfoil portion in accordance with various aspects described herein.

FIG. 5 is a schematic cross-sectional view of the airfoil portion as seen from sectional line IV-IV of FIG. 2, further illustrating the cap provided along a trailing edge of the airfoil portion in accordance with various aspects described herein.

FIG. 6 is a schematic cross-sectional view of the airfoil portion as seen from sectional line IV-IV of FIG. 2, further illustrating the cap provided along a trailing edge of the airfoil portion in accordance with various aspects described herein.

FIG. 7 is a schematic cross-sectional view of the airfoil portion as seen from sectional line IV-IV of FIG. 2, further illustrating the cap provided along a trailing edge of the airfoil portion in accordance with various aspects described herein.

FIG. 8 is a schematic perspective view of an exemplary airfoil assembly suitable for use within the turbine engine of FIG. 1, the airfoil assembly including an airfoil portion, a cap, and a dovetail.

### DETAILED DESCRIPTION

Aspects of the disclosure herein are directed to an airfoil assembly for a turbine engine. The airfoil assembly includes an airfoil portion having an outer wall with a cap. The outer wall extends between a root and a tip defining a spanwise direction. The outer wall extends between a leading edge and a trailing edge defining a chordwise direction. The cap overlies a respective portion of the outer wall. The cap has an exterior surface and a set of corrugations defined in a portion of the exterior surface, and the cap includes at least a first material having a Young's modulus greater than or equal to 1 ksi and less than or equal to 150 ksi.

The cap can cover at least an exterior portion of the airfoil assembly (e.g., the outer wall) and can protect the portion of airfoil assembly against wear during use of the airfoil assembly. The cap can increase a resistance of the airfoil assembly to operational stresses and operational strains during operation. At least a portion of the cap can define a set of corrugations that directs air flow over the airfoil portion to improve aerodynamic stability of the airfoil portion, reduce noise of the airfoil assembly during the operation of the engine to lower an acoustic signature of the airfoil assembly, or achieve a combination thereof. The set of corrugations can further tailor wake flow downstream of the airfoil portion to reduce an impact of the wake (i.e. stator wake) on downstream components of the turbine engine.

For purposes of illustration, the present disclosure will be described with respect to an airfoil assembly for a turbine engine. It will be understood, however, that aspects of the disclosure described herein are not so limited and can have general applicability within aerodynamic systems, other engines or within other portions of the turbine engine. For example, the disclosure can have applicability for an airfoil assembly in other engines or vehicles, and can be used to provide benefits in industrial, commercial, and residential applications.

It is contemplated that the turbine engine can be any suitable turbine engine such as, but not limited to, a turbofan, a turboprop, an electrically driven fan, a gas turbine engine, a steam turbine engine or a supercritical carbon dioxide turbine engine. It is further contemplated that the airfoil assembly can be a blade, a vane, a strut, an airfoil, or other component of an aerodynamic system, such as, but not limited to, an unducted fan (UDF) or open fan, contra-rotating open rotor (CROR), a ducted fan, a gas turbine engine, a turboprop engine, a turboshaft engine, a ducted turbofan engine, or an unducted turbine engine.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first” and “second” can be used interchangeably to distinguish one component from another and are not intended to signify location or importance of the individual components.

As used herein, the term “upstream” refers to a direction that is opposite the fluid flow direction, and the term “downstream” refers to a direction that is in the same direction as the fluid flow. The term “fore” or “forward” means in front of something and “aft” or “rearward” means behind something. For example, when used in terms of fluid flow, “fore” or “forward” can mean upstream and “aft” or “rearward” can mean downstream.

Additionally, as used herein, the terms “axial” and “longitudinal” both refer to a direction parallel to a centerline axis of an object, while the terms “radial” or “radially” refer to a direction that is perpendicular to the axial direction or away from a common center. For example, in the overall context of a turbine engine, radial refers to a direction along a ray extending between a center longitudinal axis of the engine and an outer engine circumference.

The singular forms “a”, “an”, and “the” include plural references unless the context clearly dictates otherwise. Furthermore, as used herein, the term “set” or a “set” of elements can be any number of elements, including only one.

Further, as used herein, the term “fluid” or iterations thereof can refer to any suitable fluid within the turbine engine at least a portion of the turbine engine is exposed to such as, but not limited to, combustion gases, ambient air, pressurized airflow, working airflow, or any combination thereof. As a non-limiting example, the term “fluid” can refer to steam in a steam turbine engine, or to carbon dioxide in a supercritical carbon dioxide turbine engine.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein.

Connection references (e.g., attached, coupled, secured, fastened, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

As used herein, when a component (e.g., a layer) is described as being “on” or “over” a respective component (e.g., another layer or a substrate) it will be appreciated that the layer can either be directly contacting the respective component or otherwise be spaced from the respective component with intervening layers disposed therebetween.

The term “composite,” as used herein is, is indicative of a component having two or more materials. A composite can be a combination of at least two or more metallic, non-metallic, or a combination of metallic and non-metallic elements or materials. Examples of a composite material can be, but are not limited to, a polymer matrix composite (PMC), a ceramic matrix composite (CMC), a metal matrix composite (MMC), carbon fibers, a polymeric resin, a thermoplastic resin, bismaleimide (BMI) materials, polyimide materials, an epoxy resin, glass fibers, and silicon matrix materials. Composite components, such as a composite airfoil, can include several layers or plies of composite material. The layers or plies can vary in stiffness, material, and dimension to achieve the desired composite component or composite portion of a component having a predetermined weight, size, stiffness, and strength.

As used herein, PMC refers to a class of materials. By way of example, the PMC material is defined in part by a prepreg, which is a reinforcement material pre-impregnated with a polymer matrix material, which could be thermoplastic, thermoset, or elastomer. Non-limiting examples of processes for producing prepregs include hot melt pre-pregging in which the fiber reinforcement material is spread then rolled between resin films in hot rollers, and powder pre-pregging in which a resin is deposited onto the fiber reinforcement material, by way of non-limiting example electrostatically, and then adhered to the fiber, by way of non-limiting example, in an oven or with the assistance of heated rollers. The prepregs can be in the form of unidirectional tapes or woven fabrics, which are then stacked on top of one another to create the number of stacked plies desired for the part.

Multiple layers of prepreg are stacked to the proper thickness and orientation for the composite component and then the resin is cured and solidified to render a fiber reinforced composite part. Resins for matrix materials of PMCs can be generally classified as thermosets or thermoplastics. Thermoplastic resins are generally categorized as polymers that can be repeatedly softened and flowed when heated and hardened when sufficiently cooled due to physical rather than chemical changes. Notable example classes of thermoplastic resins include nylons, thermoplastic polyesters, polyaryletherketones, and polycarbonate resins. Specific examples of high performance thermoplastic resins that have been contemplated for use in aerospace applications include, polyetheretherketone (PEEK), polyetherketoneketone (PEKK), polyetherimide (PEI), polyaryletherketone (PAEK), and polyphenylene sulfide (PPS). In contrast, once fully cured into a hard rigid solid, thermoset resins do not undergo significant softening when heated, but instead thermally decompose when sufficiently heated. Notable examples of thermoset resins include epoxy, bismaleimide (BMI), and polyimide resins.

Instead of using a prepreg, in another non-limiting example, with the use of thermoplastic polymer filament, it is possible to utilize a woven fabric. Woven fabric can include, but is not limited to, dry carbon fibers woven together with thermoplastic polymer fibers or filaments. Non-prepreg braided architectures can be made in a similar fashion. Additionally, different types of reinforcement fibers can be braided or woven together in various concentrations to tailor the properties of the part. For example, glass fibers, carbon fibers, and thermoplastic fibers could all be woven together in various concentrations to tailor the properties of the part. The carbon fibers provide the strength of the system, the glass fibers can be incorporated to enhance the impact properties, which is a design characteristic for parts located near the inlet of the engine, and the thermoplastic fibers provide the binding for the reinforcement fibers.

In yet another non-limiting example, resin transfer molding (RTM) can be used to form at least a portion of a composite component. Generally, RTM includes the application of dry fibers or matrix material to a mold or cavity. The dry fibers or matrix material can include prepreg, braided material, woven material, or any combination thereof. Resin can be pumped into or otherwise provided to the mold or cavity to impregnate the dry fibers or matrix material. The combination of the impregnated fibers or matrix material and the resin are then cured and removed from the mold. When removed from the mold, the composite component can require post-curing processing.

It is contemplated that RTM can be a vacuum assisted process. That is, the air from the cavity or mold can be removed and replaced by the resin prior to heating or curing. It is further contemplated that the placement of the dry fibers or matrix material can be manual or automated. As a non-limiting example, the placement of dry fibers or prepreg can be done through automatic fiber placement (AFP) or manually by hand.

The dry fibers or matrix material can be contoured to shape the composite component or direct the resin. Optionally, additional layers or reinforcing layers of a material differing from the dry fiber or matrix material can also be included or added prior to heating or curing.

As used herein, CMC refers to a class of materials with reinforcing fibers in a ceramic matrix. Generally, the reinforcing fibers provide structural integrity to the ceramic matrix. Some examples of reinforcing fibers can include, but are not limited to, non-oxide silicon-based materials (e.g., silicon carbide, silicon nitride, or mixtures thereof), non-oxide carbon-based materials (e.g., carbon), oxide ceramics (e.g., silicon oxycarbides, silicon oxynitrides, aluminum oxide (Al₂O₃), silicon dioxide (SiO₂), aluminosilicates such as mullite, or mixtures thereof), or mixtures thereof.

Some examples of ceramic matrix materials can include, but are not limited to, non-oxide silicon-based materials (e.g., silicon carbide, silicon nitride, or mixtures thereof), oxide ceramics (e.g., silicon oxycarbides, silicon oxynitrides, aluminum oxide (Al₂O₃), silicon dioxide (SiO₂), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) can also be included within the ceramic matrix.

Generally, particular CMCs can be referred to as their combination of type of fiber/type of matrix. For example, C/SiC for carbon-fiber-reinforced silicon carbide; SiC/SiC for silicon carbide-fiber-reinforced silicon carbide, SiC/SiN for silicon carbide fiber-reinforced silicon nitride; SiC/SiC—SiN for silicon carbide fiber-reinforced silicon carbide/silicon nitride matrix mixture, etc. In other examples, the CMCs can be comprised of a matrix and reinforcing fibers comprising oxide-based materials such as aluminum oxide (Al₂O₃), silicon dioxide (SiO₂), aluminosilicates, and mixtures thereof. Aluminosilicates can include crystalline materials such as mullite (3Al₂O₃·2SiO₂), as well as glassy aluminosilicates.

Such materials, along with certain monolithic ceramics (i.e., ceramic materials without a reinforcing material), are particularly suitable for higher temperature applications. Additionally, these ceramic materials are lightweight compared to superalloys, yet can still provide strength and durability to the component made therefrom. Therefore, such materials are currently being considered for many turbine components used in higher temperature sections of turbine engines, such as airfoil portions (e.g., turbines, and vanes), combustors, shrouds, and other like components, that would benefit from the lighter-weight and higher temperature capability these materials can offer.

The term “metallic” as used herein is indicative of a material that includes metal such as, but not limited to, titanium, iron, aluminum, stainless steel, and nickel alloys. A metallic material or alloy can be a combination of at least two or more elements or materials, where at least one is a metal.

As used herein, the term “cap” is a covering or protectant layer component or assembly that is coupled to and covers at least a portion of an exterior surface of the airfoil assembly (e.g., an airfoil portion outer wall). The cap can lessen wear along exterior surfaces of the airfoil assembly during operation, and thus, increase strength and durability of the airfoil assembly. The cap can have structure (e.g., a set of corrugations) to enhance acoustic and aerodynamic stability at the respective area of the airfoil portion.

As used herein, the term “corrugation”, “corrugations”, or “a set of corrugations” refers to a geometric alteration or inflection forming a shape or pattern of shapes that has extension from the surface of an object or member (e.g., an exterior surface of one or both a cap and an airfoil portion).

As used herein, the term “modulus” or “Young's modulus” refers to a measure of elasticity, or deformation, of a material under tension (strain) or compression. Young's modulus relates to an elasticity for a particular material or structure made of such material, such as the engine components described herein. Young's modulus represents the stress per unit area relative to the local strain or proportional deformation thereof.

As used herein, the term “elongation” in terms of a material refers to the strain-to-failure value and is a length the material will deform under tension before breaking. The strain-to-failure value can be expressed as a percentage of the length relative to an original length of the material (e.g., a length at rest). The terms “elongation” and “strain-to-failure value” relate to the deformation of a material or a structure composed of the material.

As used herein, the terms “overmolded”, “overmolding”, or iterations thereof refer to a process by which two or more separate components or materials are bonded to form a single part. For example, the process can involve starting with one fully fabricated component (e.g., a cured or machined component) that is placed into a mold defining a cavity larger than the component. Uncured material (e.g., liquid polymer) can be injected into the cavity to fill an empty space of the cavity and bond to or encapsulate the component to form an overmolded component. The precise nature of the bond formed depends on the type of components and materials bonded together. As a non-limiting example, two plastics bonded together can have an overmolded bond cohesive in nature. Thus, bonds formed during overmolding can couple portions of an overmolded component together. Additionally or alternatively, one or more layers of adhesive can be used to couple portions of an overmolded component together. Adhesives can include resin such as epoxies, acrylics, and phenolics, wherein the adhesive can require curing at elevated temperatures or other hardening techniques. It is contemplated that overmolding, as described herein, can be an additive manufacturing process, wherein one or more components or materials can be constructed layer-by-layer or include more than one overmolding process.

As used herein, the term “flexible plastic” refers to a polymer material having a Young's modulus greater than or equal to 1 ksi and less than or equal to 150 ksi and is also known as an elastomer.

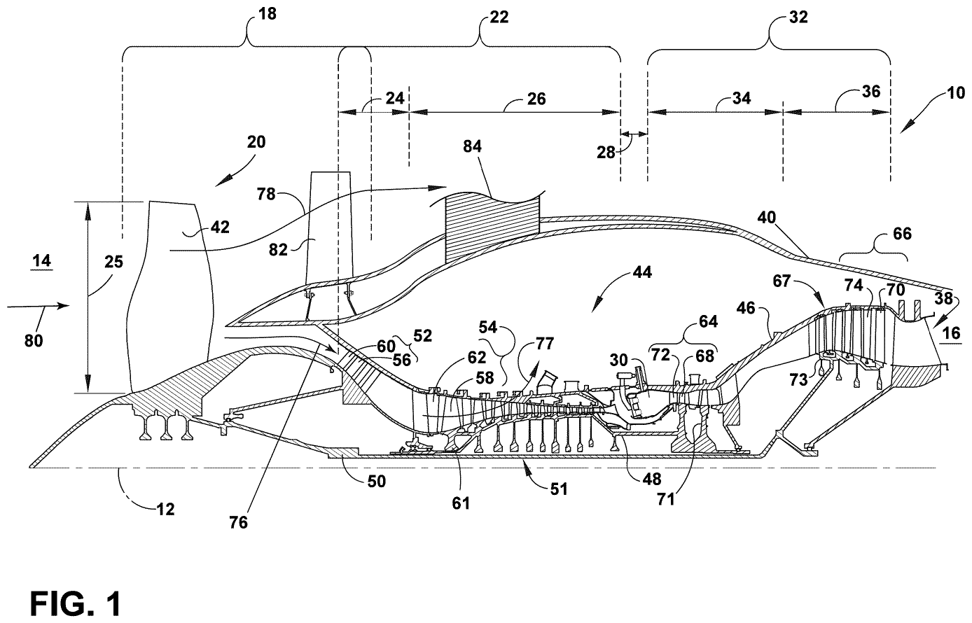

FIG. 1 is a schematic cross-sectional diagram of a turbine engine 10, specifically an open rotor or unducted turbine engine for an aircraft although the disclosure is not so limited.

The turbine engine 10 has a generally longitudinally extending axis or engine centerline 12 extending from a forward end 14 to an aft end 16. The turbine engine 10 includes, in downstream serial flow relationship, a set of circumferentially spaced blades or propellers defining a fan section 18 including a fan 20, a compressor section 22 including a booster or low pressure (LP) compressor 24 and a high pressure (HP) compressor 26, a combustion section 28 including a combustor 30, a turbine section 32 including an HP turbine 34, and an LP turbine 36, and an exhaust section 38. The turbine engine 10 as described herein is meant as a non-limiting example, and other architectures are possible, such as, but not limited to, a steam turbine engine, a supercritical carbon dioxide turbine engine, or any other suitable turbine engine.

An exterior surface, defined by a housing or nacelle 40, of the turbine engine 10 extends from the forward end 14 of the turbine engine 10 toward the aft end 16 of the turbine engine 10 and covers at least a portion of the compressor section 22, the combustion section 28, the turbine section 32, and the exhaust section 38. The fan section 18 can be positioned at a forward portion of the nacelle 40 and extend radially outward from the nacelle 40 of the turbine engine 10. The fan section 18 includes a set of fan blades 42, and a set of stationary fan outlet guide vanes 82 downstream the set of fan blades 42, both disposed radially from and circumferentially about the engine centerline 12. The set of fan blades 42 and the set of stationary fan outlet guide vanes 82 extend radially outward from respective portions of the nacelle 40. As such, the set of fan blades 42 and the set of stationary fan outlet guide vanes 82 can be defined as an external set of fan blades and an external set of stationary fan outlet guide vanes 82, respectively. The turbine engine 10 includes any number of one or more sets of rotating blades or propellers (e.g., the set of fan blades 42) disposed upstream of the set of stationary fan outlet guide vanes 82. As a non-limiting example, the turbine engine 10 can include multiple sets of fan blades 42 or multiple sets of stationary fan outlet guide vanes 82. The turbine engine 10 is further defined by the location of the fan section 18 with respect to the combustion section 28. The fan section 18 can be located upstream of the combustion section 28 (e.g., a puller fan section), downstream of the combustion section 28 (e.g., a pusher fan section), or in-line with the axial positioning of the combustion section 28.

The compressor section 22, the combustion section 28, and the turbine section 32 are collectively referred to as an engine core 44, which generates combustion gases. The engine core 44 is surrounded by an engine casing 46, which is operatively coupled with a portion of the nacelle 40 of the turbine engine 10.

An annular HP shaft 48 disposed coaxially about the engine centerline 12 of the turbine engine 10 drivingly connects the HP turbine 34 to the HP compressor 26. An annular LP shaft 50, which is disposed coaxially about the engine centerline 12 of the turbine engine 10 within the larger diameter of the annular HP shaft 48, drivingly connects the LP turbine 36 to the LP compressor 24 and fan 20. The shafts 48, 50 are rotatable about the engine centerline 12 and coupled to a set of rotatable elements, which collectively define a rotor 51.

It will be appreciated that the turbine engine 10 can be either a direct drive or integral drive engine utilizing a reduction gearbox coupling the annular LP shaft 50 to the fan 20.

The LP compressor 24 and the HP compressor 26, respectively, include a set of compressor stages 52, 54, in which a set of compressor blades 56, 58 rotate relative to a corresponding set of static compressor vanes 60, 62 to compress or pressurize the stream of fluid passing through the stage. In a compressor stage 52, 54, multiple compressor blades 56, 58 are provided in a ring and extend radially outwardly relative to the engine centerline 12, from a blade platform to a blade tip, while the corresponding static compressor vanes 60, 62 are positioned upstream of and adjacent to the compressor blades 56, 58. It is noted that the number of blades, vanes, and compressor stages shown in FIG. 1 were selected for illustrative purposes only, and that other numbers are possible.

The compressor blades 56, 58 for the stages 52, 54 of the compressor section 22 are mounted to a disk 61, which is mounted to the corresponding one of the annular HP and LP shafts 48, 50, with each stage having its own disk 61. The static compressor vanes 60, 62 for the stages 52, 54 of the compressor section 22 are mounted to the engine casing 46 in a circumferential arrangement.

The HP turbine 34 and the LP turbine 36, respectively, include a set of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage of the set of turbine stages 64, 66, multiple turbine blades 68, 70 are provided in a ring and extend radially outwardly relative to the engine centerline 12, from a blade platform to a blade tip, while the corresponding static turbine vanes 72, 74 are positioned upstream of and adjacent to the turbine blades 68, 70. It is noted that the number of blades, vanes, and turbine stages shown in FIG. 1 were selected for illustrative purposes only, and that other numbers are possible.

The turbine blades 68, 70 for stages 64, 66 of the turbine section 32 are mounted to a respective disk 71, 73, which are further mounted to the corresponding one of the annular HP and LP shafts 48, 50, thereby each stage has a respective, dedicated disk 71, 73. The static turbine vanes 72, 74 for the stages 64, 66 of the turbine section 32 are mounted to the engine casing 46 in a circumferential arrangement.

Rotary portions of the turbine engine 10, such as the compressor blades 56, 58 among the compressor section 22 and the turbine blades 68, 70 among the turbine section 32, are also referred to individually or collectively as the rotor 51. As such, the rotor 51 refers to the combination of rotating elements throughout the turbine engine 10.

Complementary to the rotary portions, the stationary portions of the turbine engine 10, such as the static compressor vanes 60, 62 among the compressor section 22 and the static turbine vanes 72, 74 among the turbine section 32, are also referred to individually or collectively as a stator 67. As such, the stator 67 refers to the combination of non-rotating elements throughout the turbine engine 10.

The nacelle 40 is operatively coupled to the turbine engine 10 and covers at least a portion of one or more of the engine core 44, the engine casing 46, or the exhaust section 38. At least a portion of the nacelle 40 extends axially forward or upstream the illustrated position. For example, the nacelle 40 extends axially forward such that a portion of the nacelle 40 overlays or covers a portion of the fan section 18 or a booster section of the turbine engine 10. The turbine engine 10 includes a pylon 84. The pylon 84 mounts the turbine engine 10 to an exterior structure (e.g., a fuselage of an aircraft, a wing, a tail wing, etc.).

During operation of the turbine engine 10, a freestream airflow 80 flows past a forward portion of the turbine engine 10. A first portion of the freestream airflow 80 flows along the nacelle 40 and over the set of stationary fan outlet guide vanes 82 as an exterior airflow 78. The exterior airflow 78 flows past the set of stationary fan outlet guide vanes 82, following the curvature of the nacelle 40 and toward the exhaust section 38. A second portion of the freestream airflow 80 enters an annular area 25 defined by a swept area between an outer surface of the nacelle 40 and a tip of the fan blade 42, with this air flow being a working airflow 76. A portion of the working airflow 76 enters the engine core 44 and is used for combustion within the engine core 44.

More specifically, the working airflow 76 flows into the LP compressor 24, which then pressurizes the working airflow 76 thus defining a pressurized airflow that is supplied to the HP compressor 26, which further pressurizes the airflow. The working airflow 76, from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the working airflow 76, or exhaust gas, is ultimately discharged from the turbine engine 10 via the exhaust section 38. The driving of the LP turbine 36 drives the annular LP shaft 50 to rotate the fan 20 and the LP compressor 24. The working airflow 76 includes the pressured airflow and flows through the compressor section 22, the combustion section 28, and the turbine section 32 of the turbine engine 10.

The working airflow 76 and at least some of the exterior airflow 78 merge downstream of the exhaust section 38 of the turbine engine 10. The working airflow 76 and the exterior airflow 78, together, form an overall thrust of the turbine engine 10.

It is contemplated that a portion of the working airflow 76 is drawn as bleed air 77 (e.g., from the compressor section 22). The bleed air 77 provides an airflow to engine components for cooling. The temperature of the working airflow 76 exiting the combustor 30 is significantly increased with respect to the working airflow 76 within the compressor section 22. As such, the bleed air 77 can provide cooling for operating of such engine components in the heightened temperature environments or a hot portion of the turbine engine 10. In the context of a turbine engine, such as the turbine engine 10, the hot portions of the engine are normally downstream of the combustor 30, especially the turbine section 32, with the HP turbine 34 being the hottest portion as it is directly downstream of the combustion section 28. Other sources of cooling fluid include, but are not limited to, fluid discharged from the LP compressor 24 or the HP compressor 26.

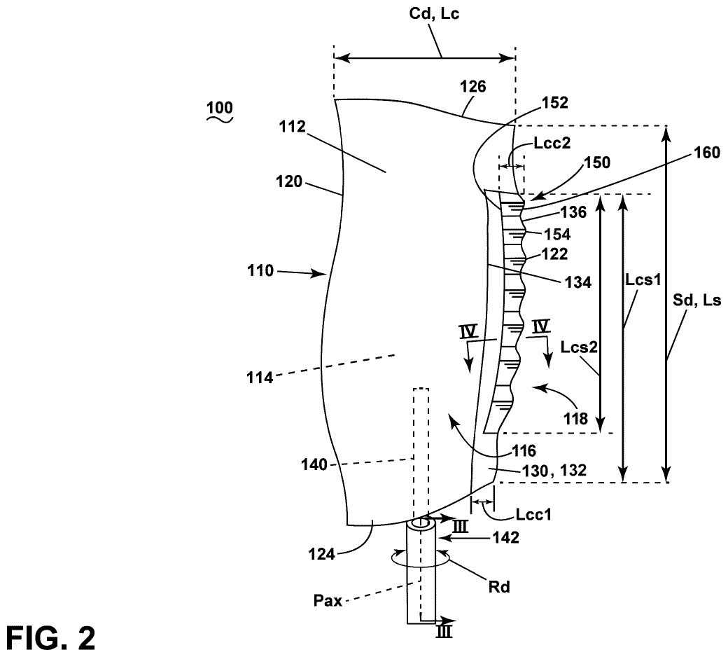

FIG. 2 is schematic illustration of an airfoil assembly 100 suitable for use within the turbine engine 10 of FIG. 1. The airfoil assembly 100 includes an airfoil portion 110. The airfoil portion 110 can be a blade, a vane, a strut, an airfoil, or other component of an aerodynamic system, such as, but not limited to, an unducted fan (UDF) or open fan, contra-rotating open rotor (CROR), a ducted fan, a gas turbine engine, a turboprop engine, a turboshaft engine, a ducted turbofan engine, or the unducted turbine engine 10 (e.g., a blade of the plurality of fan blades 42, or a blade from the compressor blades 56, 58 or the turbine blades 68, 70) (FIG. 1).

The airfoil portion 110 includes an outer wall 112 bounding an interior 114. The airfoil portion 110 includes a pressure side 116 and a suction side 118, opposite the pressure side 116. The outer wall 112 extends between a leading edge 120 and a trailing edge 122 of the airfoil portion 110 to define a chordwise direction (Cd). The outer wall 112 further extends between a root 124 and a tip 126 to define a spanwise direction (Sd).

The airfoil portion 110 has a span length (Ls) measured along the spanwise direction (Sd) from the root 124 at 0% span length (Ls) to the tip 126 at 100% span length (Ls). A chord length (Lc) can be measured between the leading edge 120 and the trailing edge 122 of the airfoil portion 110, equidistant between the pressure side 116 and the suction side 118 of the outer wall 112.

The airfoil assembly 100 can include a spar 140 and a trunnion 142, the spar 140 extending from a respective portion of the interior 114 and outwardly through the root 124 of the airfoil portion 110 into a hollow interior of the trunnion 142. The spar 140 is coupled to the trunnion 142. As such, the spar 140 couples the airfoil portion 110 to the trunnion 142. The spar 140 can couple the airfoil portion 110 and the trunnion 142 through any suitable method or combination of methods such as, but not limited to, bonding, adhesion, fastening, any other suitable coupling method, or a combination thereof.

As a non-limiting example, an entire extension of the spar 140 in the interior 114 of the airfoil portion 110 can be located below 20% of the span length (Ls). Alternatively, the spar 140 can extend into the interior 114 of the airfoil portion 110 past 20% of the span length (Ls).

One or more of the airfoil portion 110, the spar 140, and the trunnion 142 can include any suitable material such as, but not limited to, a composite material, a non-composite metallic material, or a combination thereof. It will be appreciated that the term composite material can further include metals with a composite architecture (e.g., a metal matrix composite). As a non-limiting example, the spar 140 can include a composite material while the trunnion 142 includes a metallic material. As a non-limiting example, the spar 140 can be any suitable composite material such as a 2D composite, a 3D preform composite, a laminate composite skin, a woven or a braided composite, any other suitable composite, or a combination thereof.

The airfoil assembly 100 can include a cap 130 that covers at least a portion of the airfoil assembly 100. The cap 130, as illustrated, can extend along and overlies a portion of the outer wall 112 of the airfoil portion 110. In a non-limiting example, the cap 130 can extend from the root 124 at 0% span length (Ls) and can, additionally or alternatively, extend to the tip 126 at 100% span length (Ls). It will also be appreciated, however, that the cap 130 can overlie a portion of the root 124 or extend beyond the root 124 to cover a portion of one or both of the spar 140 and the trunnion 142. The cap 130, as illustrated, is a trailing edge cap provided adjacent or otherwise overlying a portion of the trailing edge 122. While illustrated as being provided along the trailing edge 122, it will be appreciated that the cap 130 can be coupled to any other suitable portion of the airfoil portion 110. The cap 130 can be coupled to and overlie a portion of the outer wall 112 defining at least one of the leading edge 120, the trailing edge 122, the root 124, the tip 126, another portion of the outer wall 112. As a non-limiting example, the cap 130 can overlie a portion of the root 124. In some examples, the airfoil assembly 100 can include a cap (e.g., the cap 130) that overlies a respective portion of the trunnion 142. It will be appreciated that the airfoil portion 110 can include more than one cap 130. As a non-limiting example, the airfoil assembly 100 can include a cap 130 provided along the trailing edge 122, a cap provided along the leading edge 120 and a cap along the trunnion 142.

A total surface area of the airfoil portion 110 is defined as a sum of a surface area of the outer wall 112 on the pressure side 116 and a surface area of the outer wall 112 on the suction side 118. The cap 130 can overlie or otherwise cover greater than or equal to 0.6% and less than or equal to 70% of the total surface area of the airfoil portion 110. More specifically, the cap 130 overlies or otherwise covers greater than or equal to 2% and less than or equal to 60% of the total surface area of the airfoil portion 110.

The cap 130 has an exterior surface 132. The exterior surface 132 of the cap 130 can extend at least between a cap fore edge 134 and a cap aft edge 136. A set of corrugations 150 can be defined in a portion of the exterior surface 132. The set of corrugations 150 defined in the exterior surface 132 can be any suitable geometric alteration or inflection forming a shape or pattern of shapes that extends outwardly with respect to the outer wall 112. As a non-limiting example, the set of corrugations 150 can be formed as a wave extending from a corrugation fore edge 152 and to a corrugation aft edge 154, as illustrated. It will be appreciated, however, that the set of corrugations 150 can be any suitable aerodynamic or acoustic geometry such as, but not limited to, a wave, a dimple, a divot, a shark skin denticle feature, a set of riblets or drag reducing features, vortex generators, or any combination thereof. For example, the “shark skin denticle feature” geometry can be defined as a surface pattern having the appearance of grooved riblets and can advantageously reduce drag forces, or the resistance an object (i.e., airfoil assembly 100) must overcome while moving through a fluid (e.g., the working airflow 76 of FIG. 1 or the exterior airflow 78 of FIG. 1). Further, “vortex generator” geometry can be defined as “fins” or flange structures that protrude outward and can create local regions of mixing vortices (e.g., the working airflow 76 of FIG. 1 or the exterior airflow 78 of FIG. 1) over the surface of an object (i.e. airfoil assembly 100) that can minimize flow separation from the object surface, thus lowering aeromechanical loading, or aggressively mix wakes thus lowering wake interaction noise. The corrugated surface pattern of features can also be arranged to reduce the radiated noise levels associated with airfoil turbulent boundary layer self-noise.

The set of corrugations 150 can extend or be spaced along the exterior surface in the spanwise direction (Sd). The set of corrugations 150 can terminate prior to the trailing edge 122 in the chordwise direction (Cd). The set of corrugations 150 can be integrally formed with a remainder of the cap 130. Put another way, the set of corrugations 150 and the exterior surface 132 can form a unitary surface.

The cap 130 can extend in the spanwise direction (Sd) defining a cap span length (Lcs1). The cap 130 extends in the chordwise direction (Cd) defining a cap chord length (Lcc1). The cap span length (Les1) is less than or equal to the span length (Ls) as measured along a portion of the airfoil portion 110 on which the cap 130 is provided. As a non-limiting example, the cap span length (Les1) can be equal to the span length (Ls) of the airfoil portion 110 at the trailing edge 122. The cap chord length (Lcc1) can be less than or equal to the chord length (Lc).

The set of corrugations 150 extends in the spanwise direction (Sd) defining a corrugation span length (Les2). The set of corrugations 150 extends in the chordwise direction (Cd) between the corrugation fore edge 152 and the corrugation aft edge 154 defining a corrugation chord length (Lcc2). The corrugation span length (Lcs2) can be less than or equal to the cap span length (Les1). The corrugation chord length (Lcc2) can be less than or equal to the cap chord length (Lcc1).

The set of corrugations 150 can direct fluid flow over the airfoil portion 110 to improve aerodynamic stability of the airfoil portion 110, reduce noise of the airfoil assembly 100 during the operation of an engine (e.g., the turbine engine 10) to lower an acoustic signature of the airfoil assembly 100, or achieve a combination thereof.

The set of corrugations 150 can improve wake interaction along the rotating blades and the stationary vanes. For example, if the cap 130 including the set of corrugations 150 were coupled to a fan blade (e.g., the fan blade 42 of FIG. 1), the cap 130 can reduce the wake along a corresponding downstream fan vane (e.g., the stationary fan outlet guide vane 82 of FIG. 1) and thus reduce wake flow impingement.

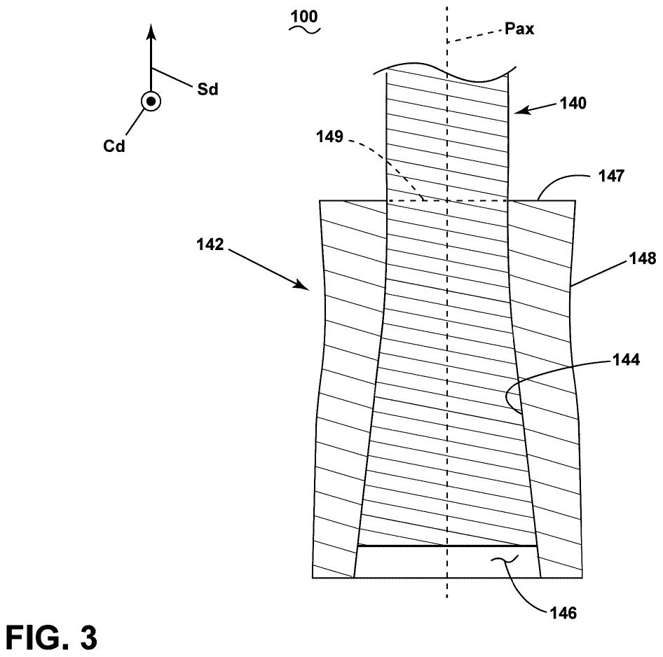

FIG. 3 is a schematic cross-sectional view of a portion of the airfoil assembly 100 as seen from sectional line III-III of FIG. 2. The spar 140 extends into a respective portion of the trunnion 142. The trunnion 142 includes a wall 148 having an interior surface 144. The interior surface 144 can define a socket 146. The socket 146 includes a cross-sectional area when viewed along a plane extending along a pitch axis (Pax). The cross-sectional area of the socket 146 is any suitable shape such as, but not limited to, rectangular, flared, curved, or a combination thereof. The trunnion 142 includes an upper edge 147 that faces the root 124 (FIG. 2) of the airfoil portion 110. The upper edge 147 is spaced from the root 124 (FIG. 2). The upper edge 147 includes an open top 149 opening to the socket 146. The spar 140 extends through the open top 149 and into the socket 146.

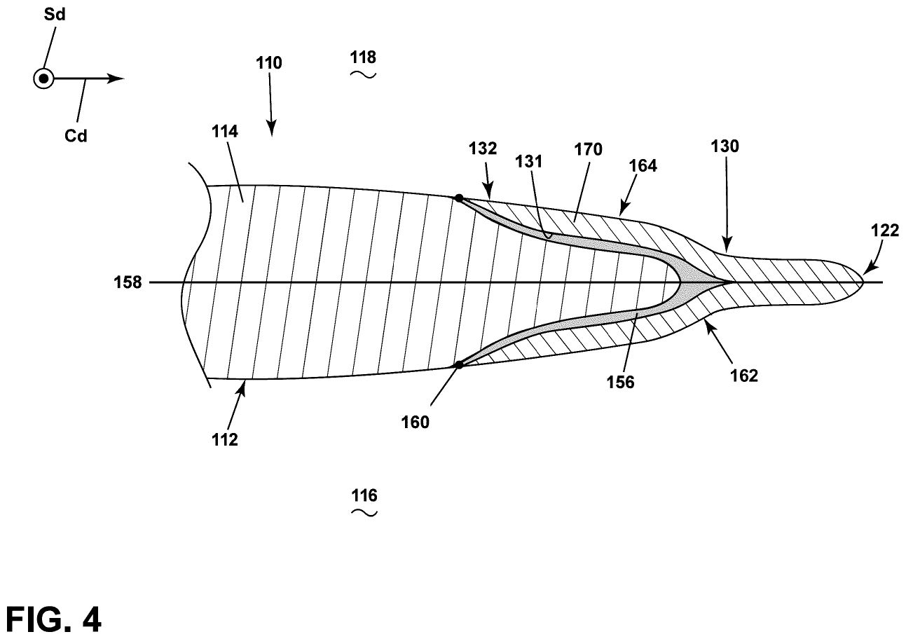

FIGS. 4-7 are schematic cross-sectional views of example configurations of the airfoil portion 110 as seen from sectional line IV-IV of FIG. 2. The airfoil portion 110 includes the interior 114 and the outer wall 112 bounding the interior 114. The interior 114 can include any suitable material and define an interior modulus. As a non-limiting example, the interior 114 can include a composite structure. The outer wall 112 can be formed as a set of laminate layers provided around or about the interior 114, including pre-impregnated, fiber placed, or dry fiber laminate layers, in non-limiting examples.

The airfoil portion 110 includes a mean camber line 158. While the cap 130 is illustrated as symmetric about the mean camber line 158 in FIGS. 4-7, the cap 130 can be asymmetric about the mean camber line 158.

The cap 130 forms an intersection at a joint 160 with a respective portion of the outer wall 112. The joint 160 is formed such that the cap 130 intersects the outer wall 112 and forms a continuous surface. The joint 160 is any suitable joint such as, but not limited to, a scarf joint, a butt joint, a lap joint, or the like. As a non-limiting example, the joint 160 is a scarf joint.

The cap 130 includes a first body 162 and a second body 164. The first body 162 overlies a respective portion of the outer wall 112 corresponding to the pressure side 116. The second body 164 overlies a respective portion of the outer wall 112 corresponding to the suction side 118. The first body 162 can be coupled to the second body 164 through any suitable coupling method such as, but not limited to, adhesion, welding, fastening, bonding, or the like. While the first body 162 and the second body 164 are illustrated as two separate bodies, the cap 130 can include any number of one or more bodies. As a non-limiting example, the cap 130 can include a single body such that the first body 162 and the second body 164 are integrally formed to define a unitary body.

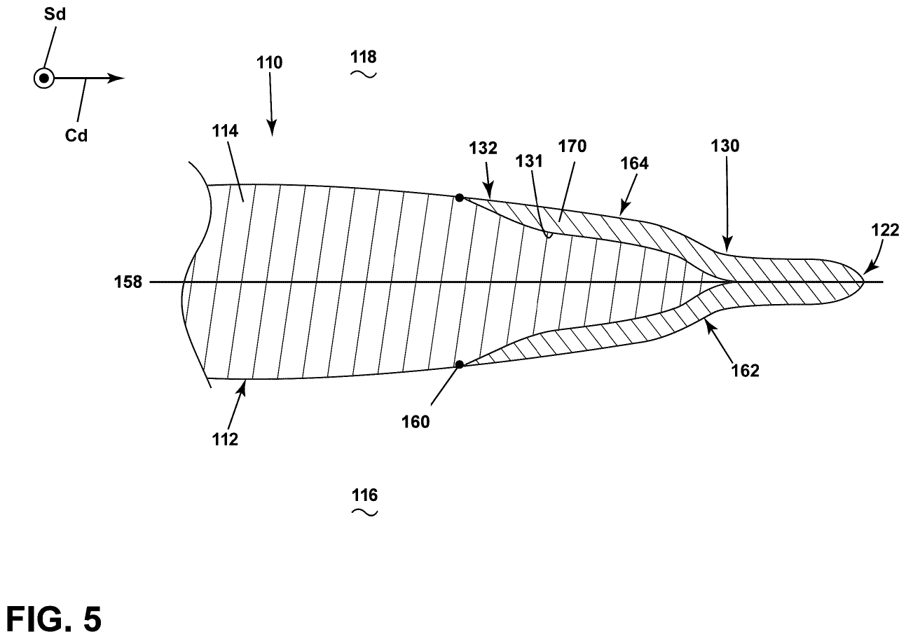

The cap 130 can include at least a first material 170 having a Young's modulus such that one or both of the first body 162 and the second body 164 define the first material 170 (FIGS. 4-5). The first Young's modulus is greater than or equal to 1 ksi and less than or equal to 150 ksi. In some examples, the first Young's modulus can be greater than or equal to 1 ksi and less than or equal to 100 ksi. In some examples, the Young's modulus of the first material 170 can be greater than or equal to 1 ksi and less than or equal to 50 ksi. The first material 170 of the cap 130 can be a flexible plastic. As such, the cap 130 can increase a resistance of the airfoil assembly 100 to operational stresses and operational strains. The first material 170 can have a strain-to-failure value greater than or equal to 10% and less than or equal to 1500%. Thus, the cap 130 can have flexibility and durability to lessen wear on the airfoil portion 110 during operation. Examples of the first material 170 can be, but are not limited to, a nitrile rubber, EPDM rubber, silicone, hydrogenated nitrile, natural rubber, fluoroelastomers, neoprene, styrene-butadiene rubber (SBR), and fluorosilicone.

In a non-limiting example, the first material can be overmolded onto a respective portion of the region of the outer wall 112. In another non-limiting example, the outer wall 112 can include a region with a geometry including at least one of waves, dimples, divots, shark skin denticle feature, a set of riblets, vortex generators, aerodynamic geometric features, acoustic geometric features, or a combination thereof and the first material can be overmolded to follow a contour of the outer wall 112 within the region to define the set of corrugations 150 (FIG. 2).

The cap 130 and the outer wall 112 can be coupled together through any suitable coupling method, such as, but not limited to adhesives, bonding, welding, fastening, or the like, or a combination thereof. An adhesive layer 156 can be provided between the cap 130 and the outer wall 112 (FIG. 4), or the cap 130 and the outer wall 112 can be bonded together during overmolding (FIG. 5). The adhesive layer 156 includes an adhesive that is any suitable adhesive such as, but not limited to, epoxy, phenolic, adhesive film, adhesive tape, cyanoacrylate, anaerobic adhesive, thermoplastic adhesive, polymeric resin, a thermoset adhesive, or a combination thereof.

With additional reference to FIGS. 2 and 3, during operation of the airfoil assembly 100, the trunnion 142 can rotate about the pitch axis (Pax) in a rotational direction (Rd). As the spar 140 couples the trunnion 142 to the airfoil portion 110, rotation of the trunnion 142 in the rotational direction (Rd) causes the airfoil portion 110 to rotate about the pitch axis (Pax). The rotation can be used to affect pitch of the airfoil assembly 100 such that the airfoil assembly 100 is defined as a variable pitch airfoil assembly. The pitch of the airfoil assembly 100 can be varied based on the operation or intended operation of the turbine engine (e.g., the turbine engine 10 of FIG. 1) the airfoil assembly 100 is included within.

During operation, the airfoil assembly 100 experiences stresses and strains associated with at least one of the rotational movement of the airfoil assembly 100, an impingement of a working airflow along the outer wall 112 of the airfoil portion 110, an external force (e.g., a force applied to the airfoil portion 110 from exterior the turbine engine 10 of FIG. 1), or a combination thereof. The stresses are in the form of at least one of a torsional stress, a bending stress, or a combination thereof. These stresses can be transferred to the spar 140 or lead to erosion and cracks developing along the trailing edge 122.

The cap 130 is formed to be flexible and can decrease stresses of the airfoil assembly 100 to the torsion and bending during operation. The first material 170 can also have a strain-to-failure value greater than or equal to 10% and less than or equal to 1500%. As such, the cap 130 can increase a resistance of the airfoil assembly 100 to operational strains. The cap 130 can improve the robustness of the airfoil portion 110 by improving resistance to erosion and external forces (e.g., foreign object impact) and thus increase the overall lifespan of the airfoil assembly 100. As a non-limiting example, the external force can include a bird strike along the airfoil assembly 100. The cap 130 can provide protection against damage along the airfoil assembly 100 by acting as an edge protector, a surface protector, or a combination thereof.

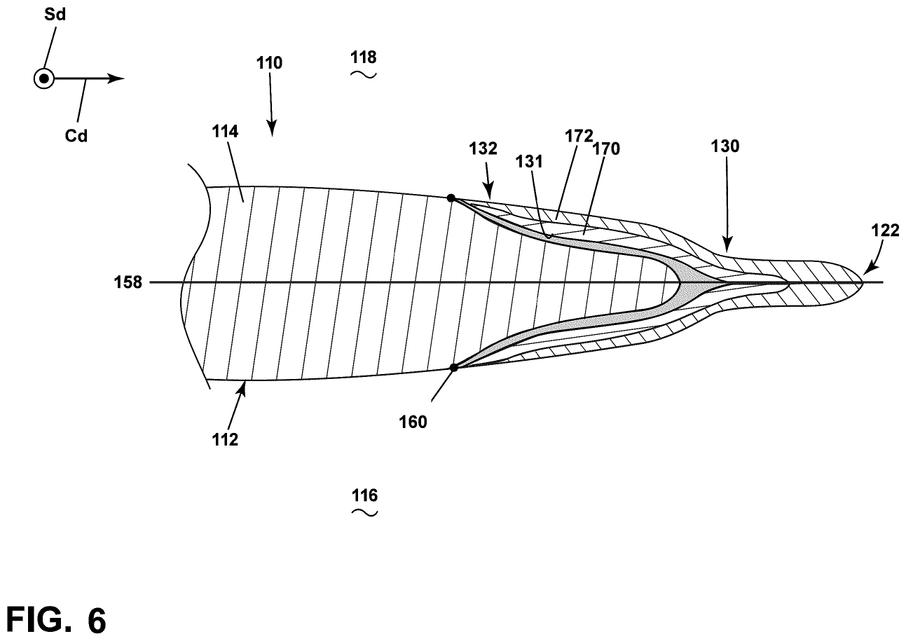

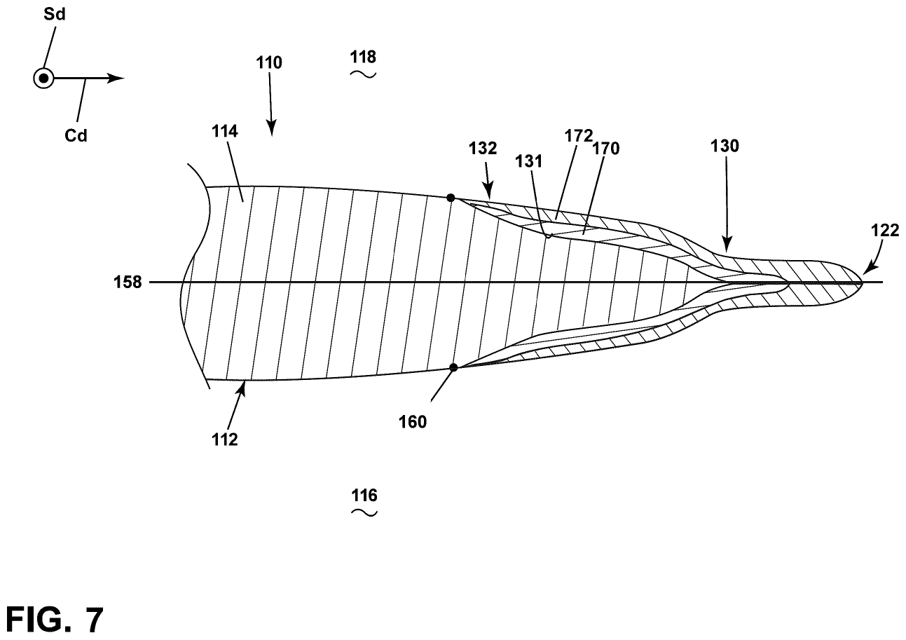

In some examples, the cap 130 can further include a second material 172 having a second Young's modulus, where the second material 172 overlays at least a portion of the first material 170 (FIGS. 6-7). The second material can be a composite material. The second material 172 is different from the first material 170. The second Young's modulus, or Young's modulus of the second material 172, can be greater than or equal to 0.2 Msi and less than or equal to 20 Msi. In a non-limiting example, the Young's modulus of the second material 172 can be greater than or equal to 0.2 Msi and less than or equal to 10 Msi. As such, the second material 172, is less flexible than the first material 170 and reinforces an exterior of the airfoil assembly 100. The second material 172 having a Young's modulus greater than or equal to 0.2 Msi and less than or equal to 20 Msi and overlaying at least a portion of the first material 170 can improve a resistance of the airfoil assembly 100 to external forces (e.g., foreign object impact) and thus increase the overall lifespan of the airfoil assembly 100. By contract, a material having a Young's modulus greater than 20 Msi can be more brittle and less resistive to external forces.

The second material 172 can be overmolded onto the first material 170. The second material 172 or any other material of the cap 130 can include any suitable material such as, but not limited to, a metal, a plastic, a glass, or a composite material, such as, but not limited to, carbon or carbon fibers, a glass or glass fibers, a nylon, a rayon, aramid fibers, nickel, titanium, ceramic composites, or combinations thereof, in non-limiting examples.

The cap 130, including first material 170 and second material 172, can be coupled to the outer wall 112 through any suitable coupling method, such as, but not limited to adhesives, bonding, welding, fastening, or the like, or a combination thereof. An adhesive layer 156 can be provided between the cap 130 to the outer wall 112 (FIG. 6), or the cap 130 and the outer wall 112 can be bonded together during overmolding (FIG. 7). The adhesive layer 156 includes an adhesive that is any suitable adhesive such as, but not limited to, epoxy, phenolic, adhesive film, adhesive tape, cyanoacrylate, anaerobic adhesive, thermoplastic adhesive, polymeric resin, a thermoset adhesive, or a combination thereof. Further, the second material can be overmolded on the first material for forming the cap 130.

The material of a conventional cap is predominantly metallic. Thus, the material of the cap 130 in the present disclosure comprising flexible plastic has a reduced weight and modulus compared to conventional cap. The reduction in weight of the airfoil assembly 100 reduces the overall weight of the turbine engine (e.g., the turbine engine 10 of FIG. 1). The reduction in modulus reduces the maximum stresses the airfoil assembly 100 can experience during operation. The reduction of overall weight of the turbine engine, in turn, increases the efficiency of the turbine engine.

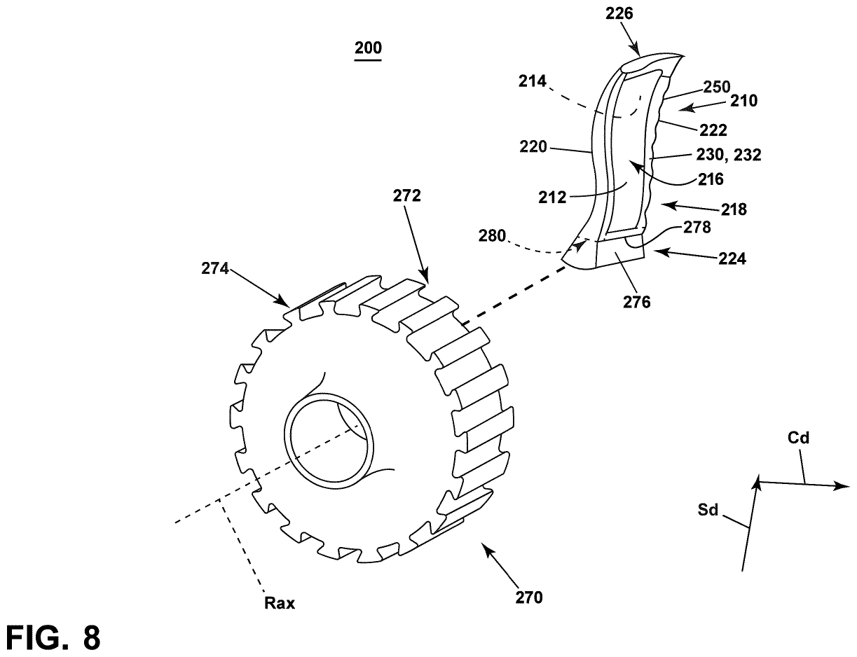

FIG. 8 is a schematic perspective view of an airfoil assembly 200 suitable for use within the turbine engine 10 of FIG. 1. The airfoil assembly 200 is similar to the airfoil assembly 100 (FIG. 2); therefore, like parts will be identified with like numerals increased to the 200 series with it being understood that the description of the airfoil assembly 100 applies to the airfoil assembly 200 unless noted otherwise.

The airfoil assembly 200 includes an airfoil portion 210. The airfoil portion 210 includes an outer wall 212 extending between a leading edge 220, a trailing edge 222, a root 224, and a tip 226. The airfoil portion 210 includes the outer wall 212 bounding an interior 214. The airfoil portion 210 includes a pressure side 216 and a suction side 218, opposite the pressure side 216. The airfoil assembly 200 includes a cap 230 provided along at least one edge of the airfoil portion 210. As a non-limiting example, the cap 230 is provided along the trailing edge 222. The cap 230 has an exterior surface 232 and includes a set of corrugations 250 defined in a portion of the exterior surface and is coupled to the airfoil portion 210.

The airfoil assembly 200 is similar to the airfoil assembly 100 (FIG. 2) in that the airfoil assembly 200 includes the cap 230 provided along a respective portion of the outer wall 212 of the airfoil portion 210. The airfoil assembly 200, however, further includes a rotatable disk 270. The rotatable disk 270 is rotatable about a rotational axis (Rax).

The rotatable disk 270 includes a plurality of slots 272 extending axially through a peripheral surface 274 of the rotatable disk 270. The plurality of slots 272 are circumferentially spaced about the rotatable disk 270, with respect to the rotational axis (Rax). The rotatable disk 270 is suitable for use as the rotatable disk 61, 71, 73 (FIG. 1) or any other disk such as, but not limited to, a disk within the fan section 18 (FIG. 1), the compressor section 22 (FIG. 1), or the turbine section 32 (FIG. 1) of the turbine engine 10 (FIG. 1).

The root 224, in a dovetail configuration as shown, forms a dovetail portion 276 extending from a base 278 of the airfoil portion 210. For purposes of illustration, a transition 280 between the dovetail portion 276 and the airfoil portion 210 has been illustrated in dashed lines. The dovetail portion 276 can flare circumferentially outward from the base 278 of the airfoil portion 210.

The airfoil assembly 200 is coupled to the rotatable disk 270 by inserting the airfoil assembly 200, specifically the dovetail portion 276, into a respective slot of the plurality of slots 272. Once the airfoil assembly 200 is inserted, the airfoil portion 210 extends radially outward from the peripheral surface 274. The airfoil assembly 200 is held in place by frictional contact with the plurality of slots 272 or can be coupled to the plurality of slots 272 via any suitable coupling method such as, but not limited to, welding, adhesion, fastening, or the like. While only a single airfoil portion 210 is illustrated, it will be appreciated that there can be any number of one or more airfoil portions 210 coupled to the rotatable disk 270. As a non-limiting example, there can be a plurality of airfoil portions 210 corresponding to a total number of slots of the plurality of slots 272.

Benefits associated with the present disclosure include a cap with a reduced weight compared to a conventional cap for a conventional airfoil assembly. For example, the conventional cap can primarily include metallic material. The cap as described herein, however, includes a first material having a Young's modulus greater than or equal to 1 ksi and less than or equal to 150 ksi. Put another way, the cap as described herein includes a flexible plastic that is more lightweight than the metallic material of the conventional cap. The reduction in the weight, in turn, reduces the overall weight of the airfoil assembly 100, 200 and the turbine engine, thus increasing the overall efficiency of the turbine engine when compared to a turbine engine including the conventional airfoil assembly. Further, as the cap includes at least a first material having a Young's modulus greater than or equal to 1 ksi and less than or equal to 150 ksi, the cap is more flexible than the conventional metallic cap. By being more flexible, the cap as described herein is more resistive to cracking and can, in turn, improve a resistance of the airfoil assembly to torsional stresses and bending stresses experienced during operation, thus, increasing the overall lifespan of the airfoil assembly. The cap as described herein can include a second material overlaying the first material, where the second material has a Young's modulus greater than or equal to 0.2 Msi and less than or equal to 20 Msi. Put another way, the cap as described herein, including a flexible plastic reinforced by the second material, is more lightweight than the conventional cap formed from metallic material. The cap as described herein can be more resistive to cracking than the conventional metallic cap and can be reinforced to improve resistance to erosion and external force (e.g., foreign object impact) and thus increase the overall lifespan of the airfoil assembly.

Additional benefits of the present disclosure include an airfoil assembly with a decreased burden of manufacture when compared to the conventional airfoil assembly. A cap that is overmolded in an airfoil assembly can be readily adapted to produce a variety of complex shapes and geometries, including but not limited to waves, dimples, divots, shark skin denticle features, aerodynamic geometric features, acoustic geometric features. A conventional cap that is machine sculpted would be limited by the machine structure and size. Further, any alterations to the machine sculpted cap geometry would incur additional expenses such as new machine parts.

To the extent not already described, the different features and structures of the various embodiments can be used in combination, or in substitution with each other as desired. That one feature is not illustrated in all of the embodiments is not meant to be construed that it cannot be so illustrated but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects are provided by the subject matter of the following clauses:

An airfoil assembly comprising: an airfoil portion having an outer wall extending between a root and a tip in a spanwise direction, and between a leading edge and a trailing edge in a chordwise direction, the outer wall defining a pressure side and a suction side; and a cap overlying a portion of the outer wall, wherein the cap has an exterior surface and a set of corrugations defined in a portion of the exterior surface, and the cap includes at least a first material having a Young's modulus greater than or equal to 1 ksi and less than or equal to 150 ksi.

The airfoil assembly of any preceding clause, wherein the cap is provided along at least a portion of the trailing edge.

The airfoil assembly of any preceding clause, wherein the cap is overmolded along the portion of the outer wall.

The airfoil assembly of any preceding clause, further comprising an adhesive layer between the cap and the portion of the outer wall.

The airfoil assembly of any preceding clause, wherein the Young's modulus of the first material is greater than or equal to 1 ksi and less than or equal to 100 ksi.

The airfoil assembly of any preceding clause, wherein the Young's modulus of the first material is greater than or equal to 1 ksi and less than or equal to 50 ksi.

The airfoil assembly of any preceding clause, wherein the first material is a flexible plastic.

The airfoil assembly of any preceding clause, wherein the first material has a strain-to-failure value greater than or equal to 10% and less than or equal to 1500%.

The airfoil assembly of any preceding clause, wherein the cap further includes a second material overlying at least a portion of the first material.

The airfoil assembly of any preceding clause, wherein the second material is a composite material.

The airfoil assembly of any preceding clause, wherein the second material has a Young's Modulus greater than or equal to 0.2 Msi and less than or equal to 20 Msi.

The airfoil assembly of any preceding clause, wherein an intersection of the outer wall and the cap comprises a scarf joint.

The airfoil assembly of any preceding clause, wherein the set of corrugations terminates prior to the trailing edge in the chordwise direction.

The airfoil assembly of any preceding clause, wherein the set of corrugations includes at least one of waves, dimples, divots, shark skin denticle features, riblets, vortex generators, aerodynamic geometric features, acoustic geometric features, or a combination thereof.

The airfoil assembly of any preceding clause, wherein: the outer wall includes a region with a geometry including at least one of waves, dimples, divots, shark skin denticle features, riblets, vortex generators, aerodynamic geometric features, acoustic geometric features, or a combination thereof along the outer wall; and the first material is overmolded onto a respective portion of the region of the outer wall, the first material following a contour of the outer wall within the region to define the set of corrugations.

The airfoil assembly of any preceding clause, wherein the cap overlies a portion of the root.

The airfoil assembly of any preceding clause, wherein the cap extends beyond the root to cover a portion of one or both of the spar and the trunnion.

The airfoil assembly of any preceding clause, wherein the outer wall bounds an interior, and the airfoil assembly comprises: a spar coupled to the airfoil portion and extending into at least a portion of the interior; and a trunnion having an upper edge with an open top, and a wall having an interior surface defining a socket extending from the open top, the spar extending into the socket.

A turbine engine comprising: a fan section; and the airfoil assembly of any preceding clause, with the airfoil assembly being provided within the fan section.

An airfoil assembly comprising: an airfoil portion having an outer wall extending between a root and a tip in a spanwise direction, and between a leading edge and a trailing edge in a chordwise direction, the outer wall defining a suction side and a pressure side; and a cap overmolded along a portion of the outer wall and defining a portion of the trailing edge, wherein the cap includes a first material having a first Young's modulus and a second material defining a second Young's modulus, the first Young's modulus is greater than or equal to 1 ksi and less than or equal to 150 ksi, the second Young's modulus is greater than or equal to 0.2 Msi and less than or equal to 20 Msi, and the second material is overmolded on the first material.

The airfoil assembly of any preceding clause, wherein the cap has an exterior surface and a set of corrugations defined in a portion of the exterior surface.

A turbine engine comprising a compression section, a combustion section, and a turbine section in serial flow arrangement, and airfoil assembly comprising an airfoil portion having an outer wall extending between a root and a tip in a spanwise direction, and between a leading edge and a trailing edge in a chordwise direction, the outer wall defining a pressure side and a suction side; and a cap overlying a portion of the outer wall, wherein the cap has an exterior surface and a set of corrugations defined in a portion of the exterior surface, and the cap includes at least a first material having a Young's modulus greater than or equal to 1 ksi and less than or equal to 150 ksi.

The turbine engine assembly of any preceding clause, wherein the cap is provided along at least a portion of the trailing edge.

The turbine engine assembly of any preceding clause, wherein the cap is overmolded along the portion of the outer wall.

The turbine engine assembly of any preceding clause, wherein the airfoil assembly further comprises an adhesive layer between the cap and the portion of the outer wall.

The turbine engine of any preceding clause, wherein the Young's modulus of the first material is greater than or equal to 1 ksi and less than or equal to 100 ksi.

The turbine engine of any preceding clause, wherein the Young's modulus of the first material is greater than or equal to 1 ksi and less than or equal to 50 ksi.

The turbine engine of any preceding clause, wherein the first material is a flexible plastic.

The turbine engine of any preceding clause, wherein the first material has a strain-to-failure value greater than or equal to 10% and less than or equal to 1500%.

The turbine engine of any preceding clause, wherein the cap further includes a second material overlying at least a portion of the first material.

The turbine engine of any preceding clause, wherein the second material is a composite material.

The turbine engine of any preceding clause, wherein the second material has a Young's Modulus greater than or equal to 0.2 Msi and less than or equal to 20 Msi.

The turbine engine of any preceding clause, wherein an intersection of the outer wall and the cap comprises a scarf joint.

The turbine engine of any preceding clause, wherein the set of corrugations terminates prior to the trailing edge in the chordwise direction.

The turbine engine of any preceding clause, wherein the set of corrugations includes at least one of waves, dimples, divots, shark skin denticle features, riblets, vortex generators, aerodynamic geometric features, acoustic geometric features, or a combination thereof.

The turbine engine of any preceding clause, wherein: the outer wall includes a region with a geometry including at least one of waves, dimples, divots, shark skin denticle features, riblets, vortex generators, aerodynamic geometric features, acoustic geometric features, or a combination thereof along the outer wall; and the first material is overmolded onto a respective portion of the region of the outer wall, the first material following a contour of the outer wall within the region to define the set of corrugations.

The turbine engine of any preceding clause, wherein the cap overlies a portion of the root.

The turbine engine of any preceding clause, wherein the cap extends beyond the root to cover a portion of one or both of the spar and the trunnion.

The turbine engine of any preceding clause, wherein the outer wall bounds an interior, and the airfoil assembly comprises: a spar coupled to the airfoil portion and extending into at least a portion of the interior; and a trunnion having an upper edge with an open top, and a wall having an interior surface defining a socket extending from the open top, the spar extending into the socket.

A turbine engine comprising a compression section, a combustion section, and a turbine section in serial flow arrangement, and airfoil assembly comprising an airfoil portion having an outer wall extending between a root and a tip in a spanwise direction, and between a leading edge and a trailing edge in a chordwise direction, the outer wall defining a suction side and a pressure side; and a cap overmolded along a portion of the outer wall and defining a portion of the trailing edge, wherein the cap includes a first material having a first Young's modulus and a second material defining a second Young's modulus, the first Young's modulus is greater than or equal to 1 ksi and less than or equal to 150 ksi, the second Young's modulus is greater than or equal to 0.2 Msi and less than or equal to 20 Msi, and the second material is overmolded on the first material.

The turbine engine of any preceding clause, wherein the cap has an exterior surface and a set of corrugations defined in a portion of the exterior surface.

1. An airfoil assembly comprising:
an airfoil portion having an outer wall extending between a root and a tip in a spanwise direction, and between a leading edge and a trailing edge in a chordwise direction, the outer wall defining a pressure side and a suction side; and
a cap overlying a portion of the outer wall, wherein the cap has an exterior surface and a set of corrugations defined in a portion of the exterior surface, and the cap includes:
a first material having a Young's modulus greater than or equal to 1 ksi and less than or equal to 150 ksi; and
a second material overlaying at least a portion of the first material, the second material having a Young's Modulus greater than or equal to 0.2 Msi and less than or equal to 20 Msi, the second material forming an outer surface of the airfoil that during operation of the airfoil assembly a working airflow flows against.

2. The airfoil assembly of claim 1, wherein the cap is provided along at least a portion of the trailing edge.

3. The airfoil assembly of claim 1, wherein the cap is overmolded along the portion of the outer wall.

4. An airfoil assembly comprising:
an airfoil portion having an outer wall extending between a root and a tip in a spanwise direction, and between a leading edge and a trailing edge in a chordwise direction, the outer wall defining a pressure side and a suction side;
a cap overlying a portion of the outer wall, wherein the cap has an exterior surface and a set of corrugations defined in a portion of the exterior surface, and the cap includes at least a first material having a Young's modulus greater than or equal to 1 ksi and less than or equal to 150 ksi; and
an adhesive layer located between the cap and the portion of the outer wall, the adhesive layer being formed of a material that is different from the first material.

5. The airfoil assembly of claim 1, wherein the Young's modulus of the first material is greater than or equal to 1 ksi and less than or equal to 100 ksi.

6. The airfoil assembly of claim 1, wherein the Young's modulus of the first material is greater than or equal to 1 ksi and less than or equal to 50 ksi.

7. The airfoil assembly of claim 1, wherein the first material is a flexible plastic.

8. The airfoil assembly of claim 1, wherein the first material has a strain-to-failure value greater than or equal to 10% and less than or equal to 1500%.

9. The airfoil assembly of claim 4, wherein the cap further includes a second material overlying at least a portion of the first material.

10. The airfoil assembly of claim 1, wherein the second material is a composite material.

11. The airfoil assembly of claim 9, wherein the second material has a Young's Modulus greater than or equal to 0.2 Msi and less than or equal to 20 Msi.

12. The airfoil assembly of claim 1, wherein an intersection of the outer wall and the cap comprises a scarf joint.

13. The airfoil assembly of claim 1, wherein the set of corrugations terminates at the trailing edge.

14. The airfoil assembly of claim 1, wherein the set of corrugations includes at least one of waves, dimples, divots, shark skin denticle features, riblets, vortex generators, aerodynamic geometric features, acoustic geometric features, or a combination thereof.

15. The airfoil assembly of claim 1, wherein:
the outer wall includes a region with a geometry including at least one of waves, dimples, divots, shark skin denticle features, riblets, vortex generators, aerodynamic geometric features, acoustic geometric features, or a combination thereof along the outer wall; and
the first material is overmolded onto a respective portion of the region of the outer wall, the first material following a contour of the outer wall within the region to define the set of corrugations.

16. The airfoil assembly of claim 1, wherein the cap overlies a portion of the root.

17. The airfoil assembly of claim 1, wherein the outer wall bounds an interior, and the airfoil assembly comprises:
a spar coupled to the airfoil portion and extending into at least a portion of the interior; and
a trunnion having an upper edge with an open top, and a wall having an interior surface defining a socket extending from the open top, the spar extending into the socket.

18. A turbine engine comprising:
a fan section; and
the airfoil assembly of claim 1, with the airfoil assembly being provided within the fan section.

19. An airfoil assembly comprising:
an airfoil portion having an outer wall extending between a root and a tip in a spanwise direction, and between a leading edge and a trailing edge in a chordwise direction, the outer wall defining a suction side and a pressure side; and
a cap overmolded along a portion of the outer wall and defining a portion of the trailing edge,
wherein the cap includes a first material having a first Young's modulus and a second material defining a second Young's modulus, the first Young's modulus is greater than or equal to 1 ksi and less than or equal to 150 ksi, the second Young's modulus is greater than or equal to 0.2 Msi and less than or equal to 20 Msi, and the second material is overmolded on the first material to form a unitary body with the first material.

20. The airfoil assembly of claim 19, wherein the cap has an exterior surface and a set of corrugations defined in a portion of the exterior surface.
